(19) United States
(12) Patent Application Publication
(10) Pub. No.: US 2021/0374650 A1
(43) Pub. Date: Dec. 2, 2021

(54) RIDE ASSIGNMENT SYSTEM

(71) Applicant: HopSkipDrive, Inc., Los Angeles, CA (US)

(72) Inventors: Sophy Lee, Los Angeles, CA (US); Corey McMahon, Los Angeles, CA (US); Chris Herbert, Los Angeles, CA (US); Michael Kane, Los Angeles, CA (US); Coriana Rocklein Leste, Los Angeles, CA (US); Cole Nelson, Los Angeles, CA (US); Alexander Parsons, Los Angeles, CA (US); David Werner, Los Angeles, CA (US)

(73) Assignee: HopSkipDrive, Inc., Los Angeles, CA (US)

(21) Appl. No.: 17/336,101

(22) Filed: Jun. 1, 2021

Related U.S. Application Data
(60) Provisional application No. 63/033,057, filed on Jun. 1, 2020.

(51) Int. Cl. G06Q 10/06; G06Q 50/30

(52) U.S. Cl. CPC G06Q 10/063112; G06Q 50/30

(57) ABSTRACT

The system implements a hybrid marketplace model that takes the best attributes of both “push” and “pull” based marketplace platforms. Ride requests are submitted by ride organizers and prioritized based on driver preferences and qualifications. These are then presented to drivers in an app where they can build their daily and weekly schedule, claiming the trips most desirable for them. This gives drivers the flexibility they are looking for and gives ride organizers the ability to share driver/vehicle information with their children ahead of time (giving kids comfort on who is picking them up). Meanwhile, there is also an automated system that monitors unclaimed trips (or trips that had a last-minute driver cancel), automatically adjusts the payout to a driver, and sends automated outbound messages informing drivers of a family in need. This “push” portion of the platform ensures the system will not leave a child stranded without a ride.

This patent application claims priority to U.S. Provisional Patent Application 63/033,057 filed on Jun. 1, 2020, which is incorporated by reference herein in its entirety.

### BACKGROUND OF THE SYSTEM

Currently transportation network companies (“TNCs”) offer technology platforms that enable drivers and ride requesting passengers to connect with one another and arrange for transportation. TNCs create, maintain, and operate these platforms, which individual drivers and passengers can access online and/or through a smartphone application. The goal of TNCs is to overcome the economic frictions that would otherwise preclude passengers and drivers from connecting and transacting directly with one another. Transportation platforms are used by millions of drivers and passengers each week. Parents have begun utilizing these systems to help arrange for rides their children need for school, practices, events, and the like, and to replace or supplement car-pooling requirements. Safety is a critical component of all rides resulting from interactions between users of a TNC platform, but especially for dependent passengers (e.g., minors, seniors, disabled persons, and the like) who may lack the agency and skills to react to dangerous situations. Although rides may be monitored using GPS technology enabled services, more is needed to promote safe use of a TNC platform used primarily by dependent passengers.

The common TNC platforms are “on-demand” marketplaces that allow ride organizers to book rides for immediate pick-up, match these requests with a specific driver, and then “push” the trip to the selected driver. This doesn't work for all situations. For example, for a dependent passenger (and where the passenger is not the ride organizer) there is a safety need for rides to be prearranged, and it is important for the ride organizer to communicate with the dependent passenger who their driver will be ahead of time. In addition, in the common push model, the driver does not know in advance of accessing the platform how many ride requests are available to them, for whom, or even if they will have rides or not. Drivers also have very little independence in a push model to forecast their rides and potential earnings.

With the common push model, a TNC typically assigns a driver to a requested ride immediately prior to the pick-up based on proximity, in order to maximize the utilization and efficiency of the driver base. Certain TNC ride organizers want to prearrange recurring rides so that they can receive transportation services at the same time/day to satisfy their recurring events and obligations. For these recurring rides, there is benefit to the ride organizer in being able to schedule recurring rides in order to avoid having to request them individually, and benefit to the drivers in being able to claim recurring rides so that they can plan out their earnings and rides in advance.

Marketplace platforms in related fields, such as caregiving and tutoring have also tried a strictly “pull” model where gig workers can browse available gigs at various times and dates. Such a model benefits the gig worker, as they can plan their day or week in advance. It is generally not a good fit for TNCs where trips are booked on demand. In cases where trips are booked on demand, and especially those for dependent passengers, it is problematic because if a driver suddenly becomes unavailable, the ride organizer may be left without a backup plan.

### SUMMARY

The system allows for rides to be scheduled by a ride organizer in advance of pickup, either for a single instance or as a repeating series. When a driver is browsing rides that may fit their schedule, they are then presented with the option to also claim future instances of the ride series. In addition, a driver may browse upcoming trips for any passenger or ride series they have previously driven, allowing them to claim future instances. This method allows drivers to claim multiple upcoming related instances (related either by ride time, location, or passenger) in bulk; increasing consistency while allowing the driver to maintain complete control over their schedule.

The system implements a hybrid marketplace model that takes the best attributes of both “push” and “pull” based marketplace platforms. Ride requests are submitted by ride organizers and prioritized based on driver preferences and qualifications. These are then presented to drivers in an app where they can build their daily and weekly schedule, claiming the trips most desirable for them. This gives drivers the flexibility they are looking for and gives ride organizers the ability to share driver/vehicle information with dependent passengers ahead of time (giving the dependent passenger comfort on who is picking them up). Meanwhile, there is also an automated system that monitors unclaimed trips (or trips that had a last-minute driver cancel), automatically escalates the payout to a driver, and sends automated outbound messages informing drivers of a dependent passenger in need. This “push” portion of the platform ensures the system will not leave a dependent passenger stranded without a ride.

In one embodiment, the system includes personalized incentives and bonuses for trips throughout the lifecycle of the trip, based on the likelihood of the trip to be claimed by a driver. Incentives may include escalating bonuses, exploding offers, or personalized bonuses based on an individual driver's proclivity to claim the ride (factors may include commute distance, stated preferences of driver and/or passenger, and the like). These incentives may occur immediately when a trip is booked to encourage early-claiming, the evening before pickup to encourage peace of mind for ride organizers, or immediately before the ride to replace another driver when necessary. The incentives may be presented as a multiplier of the base fare, a fixed amount bonus, a multiplier on the time or mileage rate, or as points used for loyalty tiers and rewards.

### BRIEF DESCRIPTION OF THE DRAWINGS

FIG. 1 is a flow diagram illustrating the scheduling of a ride in an embodiment of the system.

FIG. 2 is an interface illustrating a ride offered to a driver.

FIG. 3 is an interface illustrating a series of rides that can be claimed by a driver.

FIG. 4 is an interface showing a proposed claim of certain rides in a series by a driver.

FIG. 5 is an interface showing “My Series” information to a driver.

FIG. 6 is an interface showing “My Series” information about possible rides.

FIG. 7 is a flow diagram illustrating the operation of the push system in an embodiment.

FIG. 8 is a flow diagram illustrating the scheduling of a ride in an embodiment of the system.

FIG. 9 is a flow diagram illustrating the matching of a driver to a ride in an embodiment of the system.

FIG. 10 illustrates a practical implementation of an embodiment of the system.

FIG. 11 is an example embodiment of a processing system for implementing the system in an embodiment.

### DETAILED DESCRIPTION OF THE SYSTEM

The system is a method and apparatus designed to allow scheduling of a repeating series of rides, in addition to single-instance trips, so that a driver and a passenger can have control of their own scheduling. The system promotes familiarity between driver and passenger and provides a measure of security for dependent passengers. In addition, the scheduling system is a hybrid of push and pull systems, allowing the system to react to situations where a driver is not available to service one or more of a scheduled series of rides.

In the system, a ride organizer can define a single instance and/or a repeating series of rides over some time period. A dashboard, interface, app, or website is provided to allow a ride organizer to easily schedule individual rides, a series of rides, or bulk schedule a large number of series or rides. For example, a school might be a ride organizer and schedule rides using rules such as “every school day”. The system provides rules and filters that make it easy for the ride organizer to define rides. A ride organizer may be a parent, guardian, school administrator, medical professional, day care administrator, sports team administrator, and the like, who has the authority and desires to arrange for a regular series of rides for a dependent passenger. It should be understood that the present system has applicability to all passengers, and is not limited to dependent passengers.

The system may define a series by a number of rules for scheduling a ride series such as calendar recurrence (e.g., “Every Tuesday and Thursday at 3:15) or alignment with previously established dates/times (e.g., “Every day Pasadena Unified is in session, 10 minutes after final bell time”).

Another method of scheduling rides is to define a rider's schedule requirements (i.e., “must be dropped off between X & Y” or “no later than Z” or “must be picked up between A:00 & B:00”). Then, the system evaluates all rider schedules and dynamically builds optimal rides for drivers, combining riders to ensure they are picked up or arrive within their specified window. The system minimizes the number of trips/drivers required while ensuring all riders needs are met. These trips are built at some pre-defined duration before trips start so that they can be offered to and claimed by drivers. This might, for example, occur at 8:00 pm the night before the trip.

Ride details are captured and associated with one another through a back-end server through related attributes, which may include Passenger, Pick-up Location/Time, Drop-off Location/Time, Recurrence Rules/Template, Ride Organizer, and the like.

Potential drivers are able to view available rides through an app (e.g., mobile app, desktop app, browser-based app, and the like). When selecting a trip that the driver would like to complete, related future rides are presented to the driver with the ability to also claim one or all of those instances. Drivers are also able to view and claim upcoming trips organized by these related attributes. For example:

Navigating to a “My Series” page to view trips they have completed that have trips with similar Passenger, Locations, Times upcoming;

Navigating to a “My Passengers” page to view trips of passengers they have completed trips for to browse & claim upcoming available rides; and

Navigating to a “My Locations” page to view trips of locations they have completed trips for to browse and claim upcoming available rides.

Drivers are also able to receive notifications of new trips that become available that are related to trips they have previously completed.

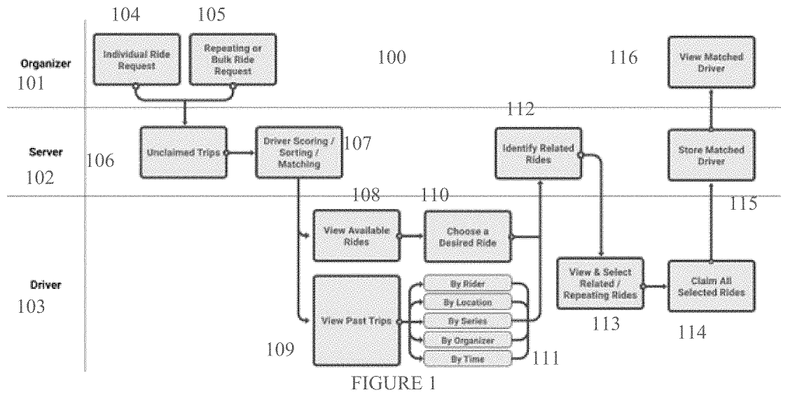

FIG. 1 is a flow diagram 100 illustrating the scheduling of a ride series in an embodiment of the system. The steps are performed by a Ride Organizer 101, at the System Server (via app, website, and the like) 102 and a Driver 103. The Organizer builds an individual ride request 104 and/or a repeating or bulk ride request 105. The System Server adds the scheduled rides to a list of unclaimed trips 106. The System Server then performs a driver scoring/setting/matching analysis 107 to provide an optimized match between the ride and one or more drivers to whom the ride will be offered. In one embodiment, the analysis is done based on preferences set by the driver.

The Driver 103 views a list of available rides 108 that are presented based on the matching analysis of step 107. The Driver can also view past trips 109 that the driver has claimed. These past trips 109 can be sorted by the filters 111 including Passenger, Location, Series, Organizer, Time, and the like. The Driver chooses a desired ride at step 110.

The System Server identifies related rides at step 112 and offers them to the Driver at step 113. This allows the Driver to fill their schedule with related rides that don't overlap or conflict with the ride they have already chosen. At step 114 the Driver claims all the rides of interest to them. At step 115 the System Server stores the matched Driver and presents the matched Driver to the Ride Organizer at step 116.

In one embodiment, trips are released to the marketplace at noon seven days prior to their scheduled start date. The system is not limited to seven days, and other time frames may be utilized as desired. This allows drivers to plan a particular time to check the pull marketplace for a critical mass of trips that enable efficient schedule building, while still having a full week in advance to plan. Any rides scheduled less than days before pickup are released to the push marketplace immediately.

Drivers set preferences in an application to filter rides regarding their personal preferences (such as when they want to drive, the minimum fare they're looking for, and how far away from a given address they would be willing to drive). The System filters and sorts rides to present to a driver based on the preferences set by the driver, preferences set by the Ride Organizer (including training qualifications, and the like), and potential conflicts with other trips already claimed by the driver. In one embodiment, once a ride is selected, the list of potential rides offered to a driver is updated to filter out rides that would no longer be feasible based on the selected ride. For example, rides that would occur wholly or in part in the same time frame as a selected ride would be filtered out.

Drivers can review trips in List View, Map View, or Calendar View. List view shows a list of trips sorted with details. In one embodiment the sorting can include various categories. For example, Recommended (which takes into account high fares, how well trips stack within their existing schedule, commute distances, any advanced qualifications they have that match the requirements, and whether they've driven the rider before), Time (which sorts chronologically by pickup), Distance, Fares, Fare/Hour, or other sorting logic.

Map View shows the route of a trip, and Calendar View shows dates on a calendar and blocks out dates that are already scheduled by the driver or if a driver has conflicts with other trips. Once the Driver claims a trip, the ride organizer is alerted to notify them of who claimed their trip and providing details (name, bio, picture, vehicle make/model/license). This information is also made available to the organizer via a mobile app and website. The alert can be via text, email, voice call, or any other suitable communication means.

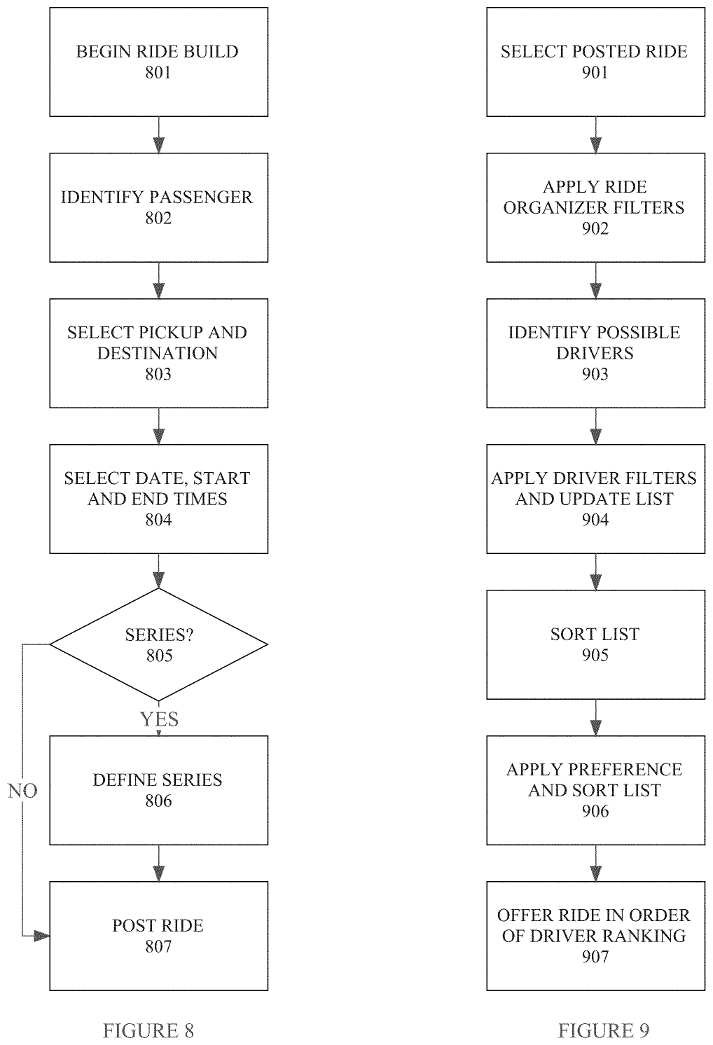

FIG. 8 is a flow diagram illustrating the building of a ride request in an embodiment of the system. At step 801 a Ride Organizer begins building a ride. The Ride Organizer will either already be registered with the system or will be invited to register with the system. At step 802 the Ride Organizer identifies the passenger. This may be a dependent passenger, the Ride Organizer themselves, or a non-dependent passenger.

At step 803 the Ride Organizer defines the pickup point and destination point of the ride. At step 804 the Ride Organizer selects the date of the ride, start time, and end time. The Ride Organizer may also define a round trip where the passenger is later picked up from the destination and returned to the pickup point at a later time, if desired.

At decision block 805 it is determined if the Ride Organizer wishes to define a series of rides with similar metrics (e.g., passenger, pickup and destination locations, start and end times, round trip designation, and the like). If so, the system presents a calendar, or other interface to define recurrence rules, to the Ride Organizer at step 806, who can then select the dates of the ride series.

After step 806, or if there is no series to be defined at decision block 805, the system proceeds to step 807 and posts the ride for a driver to claim.

FIG. 9 is a flow diagram illustrating the operation of the system in matching a driver to a ride in an embodiment. At step 901 the system selects a posted ride. At step 902 the system applies any filters that the Ride Organizer may have activated. This includes driver training qualifications, vehicle type, special equipment (lifts, baby seats, handicap access, and the like), driver rating, history of rides, geographical location, and the like.

At step 903 the system uses the Ride Organizer filters to identify possible drivers for the ride. At step 904 the system applies driver filters and updates the list by removing drivers whose filters preclude a match to the offered ride. These filters may include such metrics as when they want to drive, the minimum fare they are looking for, how far away from a given address they would be willing to drive, and the like.

At step 905 the system sorts the list based on a number of factors. These factors may include whether the driver has claimed a ride from the same passenger or ride organizer, driver rating, geographical proximity, and the like. At step 907 the system offers the rides to the remaining drivers in order of their ranking. In one embodiment, the rides are offered to all eligible drivers at the same time.

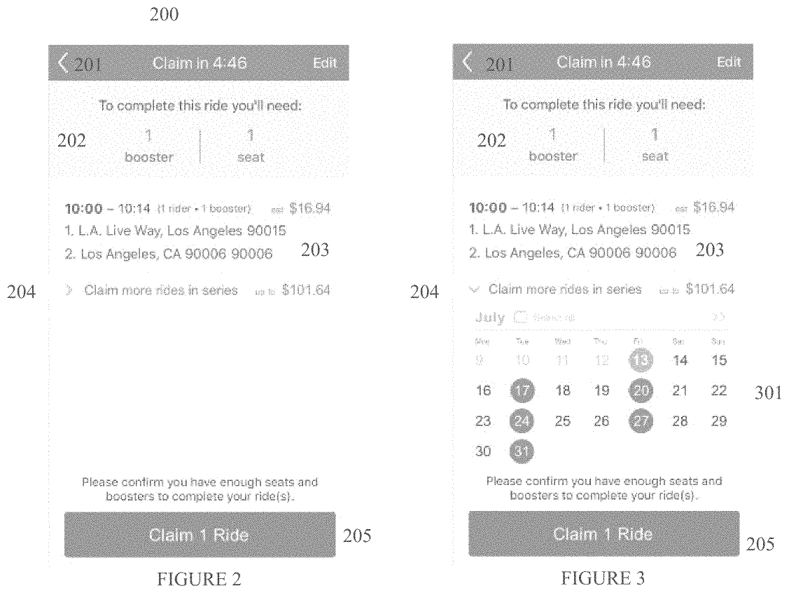

FIGS. 2 through 6 illustrate example interfaces that a Driver might see when scheduling a ride. When a ride is scheduled by a ride organizer, the ride is offered to a driver, who must then “claim” the ride. Referring to FIG. 2, the interface 200 may appear on a mobile phone, tablet, desktop display and the like. Region 201 includes a countdown timer showing how long the driver has to finalize the driver's claim to the offered ride before it is released back into the marketplace. In one embodiment, when a driver claims a ride, it is temporarily removed from the list of available rides and the rider is given a time limit to finalize the claim. If the driver does not finalize the claim before the expiration of the time limit, the ride is available again for claiming by other drivers. Region 202 illustrates requirements for the ride that might require additional equipment. For example, in FIG. 2, region 202 shows that a booster seat is needed.

Region 203 identifies the pick-up and drop-off locations, the pick-up time, and the price offered (an estimate in one embodiment). Region 204 indicates that there are more rides in the series that can be claimed if the drivers want to claim them, along with an estimated price for the series. Region 205 is the button that the driver activates to claim the ride

FIG. 3 illustrates the interface after the driver has selected the “More Rides” in series in region 204. The interface now shows a calendar in region 301 with a grey date for the current offered ride (e.g., the 13^{th}) and a different color date circle for other rides in the series. This means the ride organizer has defined the displayed circled dates as needing the same ride parameters as the offered ride. In one embodiment, the ride may be part of the same series but with one or more unique anomalous attributes (e.g., different pickup time, different drop off time or location, and the like). Such a ride may be presented in a different color or in the same color with some other indicator (e.g., an asterisk) to indicate the anomaly.

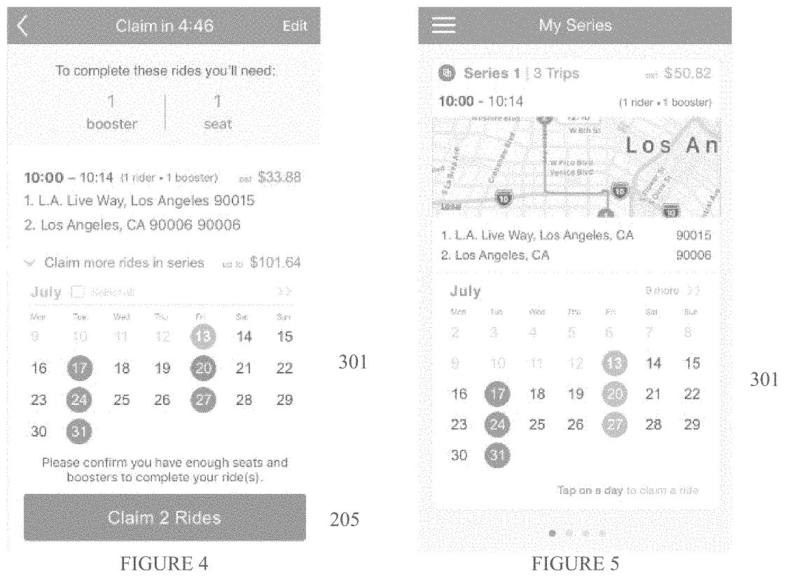

In FIG. 4, the driver has selected the 20^{th} as a date that he would like to claim in region 301. As a result, region 205 is now updated to show that the driver can now claim 2 rides. In FIG. 5, the driver has selected the “My Series” interface. This shows that the driver selected the 13^{th}, 20^{th}, and 27^{th} of the offered series, as those dates are greyed out, indicating a claimed ride.

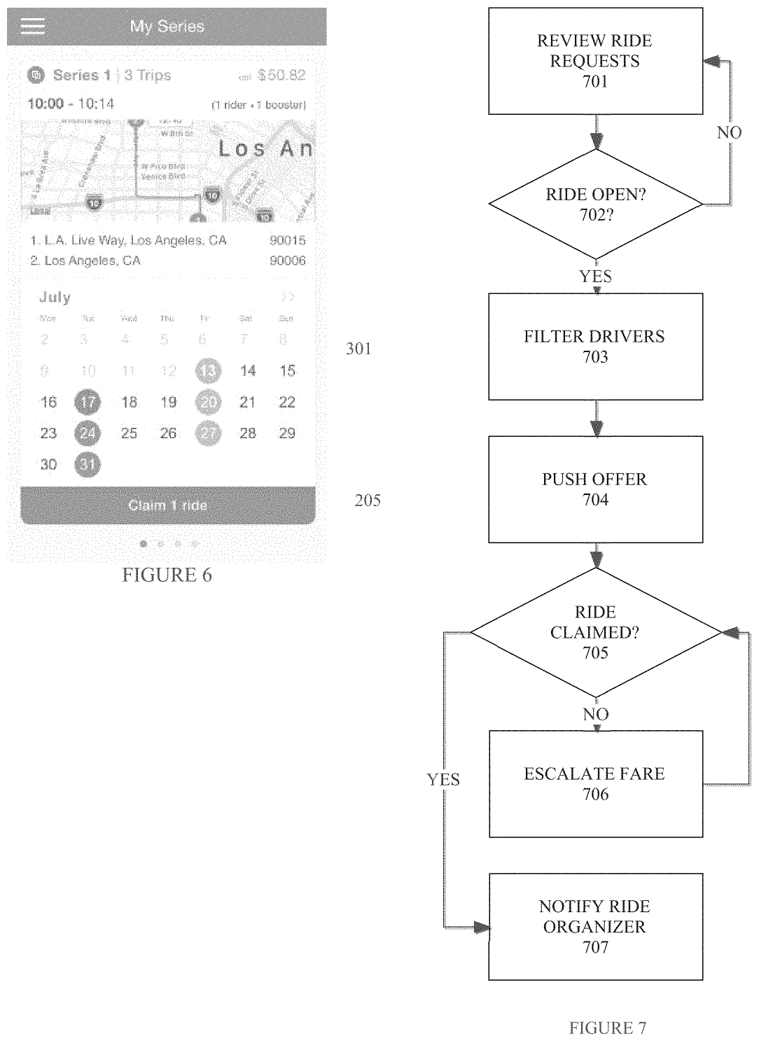

In FIG. 6, the interface of “My Series” allows the driver to claim additional dates in the series (e.g., the 17^{th}) and region 205 is updated to show an option to claim 1 ride.

The system described in FIGS. 1-6 is part of a pull model where drivers browse available rides and select the rides that best fit their schedule and preferences. However, there may be situations where a driver who has claimed a ride becomes unavailable. This may be due to illness, mechanical problems with the vehicle or other reasons. In one embodiment, the system also provides a push model that allows drivers to indicate an availability to drive in a certain region at a certain time and are sent trips that are to be performed in the near term, if not immediately. The Ride Assignment System includes an automated feature that monitors unclaimed trips (or trips that had a last-minute driver cancellation), automatically adjusts the payout to a driver (e.g., escalates the payout or creates custom bonuses), and sends automated outbound messages informing drivers of a passenger in need. This “push” portion of the platform ensures that no passenger is left stranded.

Trips that are approaching their scheduled start time and have not yet been claimed by a driver will trigger the “push” portion of the marketplace in order to help ensure the ride organizer finds a driver. This can occur where a Driver has not claimed a particular trip or where a driver has claimed a trip but is suddenly unable to complete for some reason.

Based on an escalating multiplier schedule in one embodiment, these trips will have their driver fares automatically increased as they approach the scheduled pickup time. In one embodiment, if a driver rejects a push offer, the system can immediately re-offer the ride to the same driver at a higher fare. This escalating multiplier schedule can be pre-defined by the ride organizer, or could be an automatic function and based on the amount of time remaining to schedule the ride. This multiplier schedule may be based on other factors, including supply, demand, time of day, day of week, location, passenger, requirements, and duration before scheduled pickup and may begin any time after the ride is booked but not yet claimed.

In addition, “ride opportunity” messages may be sent (SMS, push, email, calls) to drivers that are deemed good candidates to complete the ride based on:

Their current ride schedule

Their qualifications

Their past history with this passenger, location, geographic region, or time of day

Their time, distance, fare preferences

The ride's proximity to their home address

The ride's proximity to their current location

The messages indicate that there is a passenger in need and that a trip has had a multiplier applied to its fare with a link directly to the trip in the driver app. Fare increases or “ride opportunity” messages may also be triggered by the Safe Ride Support system

FIG. 7 is a flow diagram illustrating the operation of the push model in one embodiment of the system. At step 701 the system reviews scheduled rides. At decision block 702 it is determined if there are any unclaimed rides. The unclaimed rides can include newly scheduled rides that have not yet been claimed, as well as previously claimed rides that have now become open for various reasons (unavailable driver, driver decided to withdraw claim, and the like). If not, the system returns to step 701 and continues monitoring the rides.

If there are unclaimed rides at step 702, the system proceeds to step 703 and filters the drivers to identify one or more drivers who qualify to take the open ride. At step 704 the system pushes an offer of a ride to the qualified drivers. The rides will have a fare adjustment or escalating multiplier schedule over a prescheduled ride, due to the time urgency of the need to find a driver. At decision block 705 it is determined if the offered ride is claimed.

If the ride is not claimed at step 705, the system proceeds to step 706 and escalates the fare pursuant to a schedule based on a number of factors, including how much time is remaining till the commencement of the ride. After the fare escalation at step 706, the system returns to step 705. In one embodiment, the open ride with an escalated fare may be offered to a driver who has already turned down the ride. In one embodiment, a driver may actively decline the ride with a button in the app. In that case, the driver may be immediately presented with the same ride at an increased fare.

If the ride is claimed at step 705, the system moves to step 707 where the system notifies the ride organizer and takes the ride out of the open ride listing.

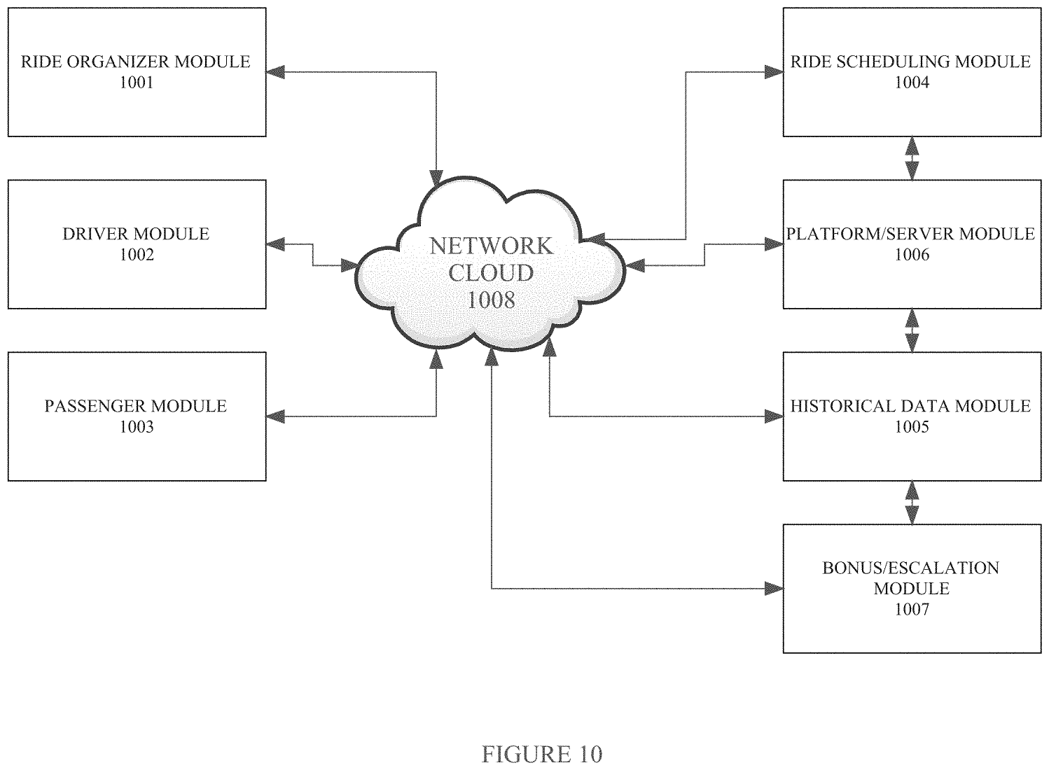

FIG. 10 is a block diagram of a practical implementation of the system through the components shown in FIG. 10. The Organizer Module 1001 comprises a processing system and software that allows for the verification of an authorized organizer to initiate the scheduling of rides for one or more passengers. The Organizer Module 1001 also allows the tracking of rides. The Organizer Module 1001 may be implemented on a computer, tablet, mobile phone, or other processing device and communicates with the Server Module 1006 via Network Cloud 1008 (e.g., the Internet).

The Server Module 1006 implements the operation of the system, admits users, and facilitates communication between the other modules. The Historical Data Module 1006 maintains a database of rides, drivers performance, passengers, and other information related to arranging and monitoring rides.

The Ride Scheduling Module 1004 performs the operations of FIGS. 8 and 9 to enable rides to be posted and to offer rides to drivers. The Ride Scheduler Module 1006 uses information from the Historical Data Module 1005 and Bonus/Escalation Module 1007 to maximize the chances of rides being claimed by a driver.

The Driver Module 1002 may be implemented on a laptop, mobile phone, and/or tablet computing device as purpose-built hardware and/or software programming. The Driver Module 1002 is used by a driver to receive potential rides, to accept and schedule rides, to receive multi-factor identification information about a passenger, to confirm passenger identity, and to provide tracking information during the ride.

The Passenger Module 1003 may be a cell phone, tablet, laptop, or other computing device that may be used by the passenger and accessed by the system to inform the passenger about the ride, and to provide additional ride tracking information. In one embodiment, the system does not require a Passenger Module 1003 and can function without one as necessary.

The Bonus/Escalation Module 1007 is used to calculate and offer the bonuses and/or escalation fares to entice a driver to choose a ride. This is implemented, for example, when a previously claimed ride has been unclaimed for some reason. In one embodiment, this module is invoked when the time period prior to the offered ride is less than a threshold amount (e.g., less than seven days in advance).

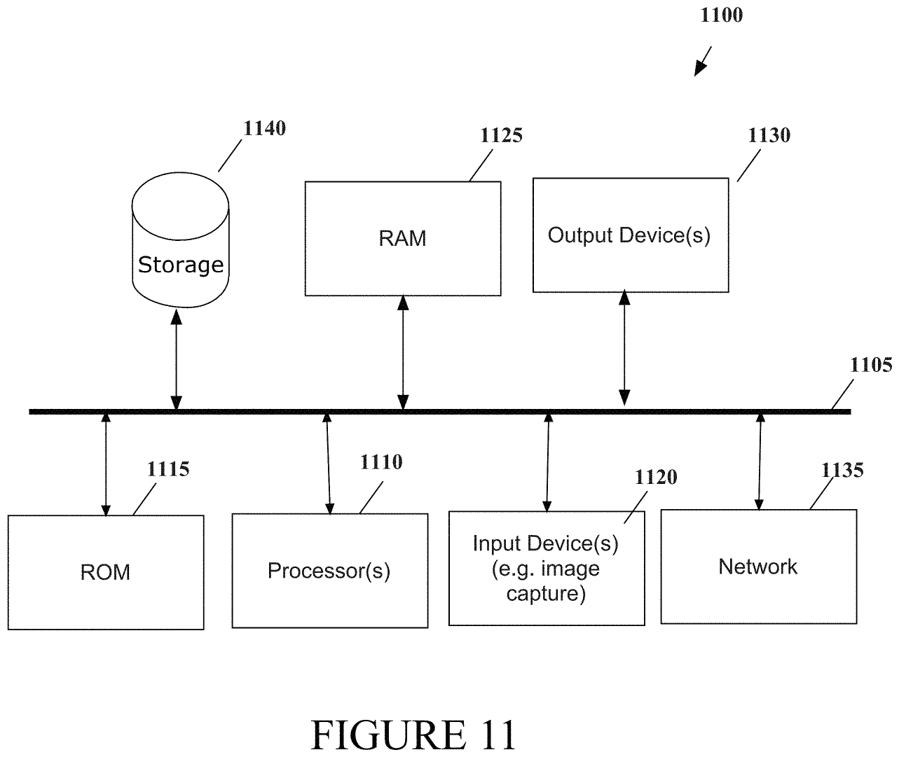

FIG. 11 illustrates an exemplary system 1100 that may implement the system. The electronic system 1100 of some embodiments may be a mobile apparatus. The electronic system includes various types of machine-readable media and interfaces. The electronic system includes a bus 1105, processor(s) 1110, read only memory (ROM) 1115, input device(s) 1120, random access memory (RAM) 1125, output device(s) 1130, a network component 1135, and a permanent storage device 1140.

The bus 1105 communicatively connects the internal devices and/or components of the electronic system. For instance, the bus 1105 communicatively connects the processor(s) 1110 with the ROM 1115, the RAM 1125, and the permanent storage 1140. The processor(s) 1110 retrieve instructions from the memory units to execute processes of the invention.

The processor(s) 1110 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine-readable storage medium (also referred to as machine readable medium). When these instructions are executed by one or more of the processor(s) 1110, they cause the processor(s) 1110 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 1110. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 1100, define one or more specific machine implementations that execute and perform the operations of the software programs.

The ROM 1115 stores static instructions needed by the processor(s) 1110 and other components of the electronic system. The ROM may store the instructions necessary for the processor(s) 1110 to execute the processes provided by the system. The permanent storage 1140 is a non-volatile memory that stores instructions and data when the electronic system 1100 is on or off. The permanent storage 1140 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 1125 is a volatile read/write memory. The RAM 1125 stores instructions needed by the processor(s) 1110 at runtime, the RAM 1125 may also store the real-time video or still images acquired by the system. The bus 1105 also connects input and output devices 1120 and 1130. The input devices enable the user to communicate information and select commands to the electronic system. The input devices 1120 may be a keypad, image capture apparatus, or a touch screen display capable of receiving touch interactions. The output device(s) 1130 display images generated by the electronic system. The output devices may include printers or display devices such as monitors.

The bus 1105 also couples the electronic system to a network 1135. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, a method and apparatus for assigning rides to drivers has been described.

What is claimed is:

1. A method of providing a ride to a driver comprising:
identifying metrics of the ride;
identifying at least one driver from a plurality of possible drivers that can provide the ride;
offering the ride to the driver;
assigning the ride to the driver if the driver claims the offered ride.

2. The method of claim 1 wherein the metrics of the ride include passenger, pickup location, destination, pickup time, and drop-off time.

3. The method of claim 1 wherein the metrics of the ride include an offered fare.

4. The method of claim 1 further including offering a previously claimed ride to the driver.

5. The method of claim 4 wherein a bonus is offered to the driver to take the previously claimed ride.

6. The method of claim 5 wherein the bonus escalates in value until the previously claimed ride is claimed by the driver.

7. The method of claim 1 further including offering a series of rides to the driver having the same metrics as the ride.
